(19) United States
(12) Patent Application Publication
(10) Pub. No.: US 2008/0281949 A1
(43) Pub. Date: Nov. 13, 2008

(54) CLIENT LOCATION INFORMATION

(75) Inventor: Justin A. Aborn, Hingham, MA (US)

Correspondence Address: OCCHIUTI ROHLICEK & TSAO, LLP, 10 FAWCETT STREET, CAMBRIDGE, MA, 02138, US

(73) Assignee: Bridgeport Networks, Inc., Chicago, IL (US)

(21) Appl. No.: 11/746,378

(22) Filed: May 9, 2007

(51) Int. Cl. G06F 15/177

(52) U.S. Cl. 709/222

(57) ABSTRACT

Location information for a client is determined prior to establishing a communication tunnel over which the client accesses network based services. The location information is passed over the communication tunnel, and the network based services are provided based on the location information.

### BACKGROUND

This invention relates to locating a client on a data network.

Some network based services make use of the location of a client computer accessing those services. Location can be expressed, for example, in terms of a geographic location such as latitude and longitude, or in network related terms such as a routable Internet Protocol (IP) address of the client.

Client computers sometimes establish communication tunnels to servers across the Internet, and their communication first passes over such tunnels before being sent to other computers. For example, from a remote location a mobile worker may establish a tunnel to access a corporate Local Area Network (LAN); thereafter, all their communication, even with a server that is not on the corporate LAN, passes first over the tunnel.

### SUMMARY

In one aspect, in general, a method for accessing a network based service includes establishing communication between a first device and a wide area data network. Information characterizing a location of the first device is obtained over the wide area network. Communication is routed to a first server via a second server, which is at a location not characterized by the obtained information. The information characterizing the location of the first device is passed from the first device via the first server to the second server.

Aspects can include one or more of the following features.

Routing communication to the first server via the second server includes forming a communication tunnel to the second server for communication from the first device.

The routing of communication via the second server is initiated after obtaining the information characterizing the location of the first device.

While routing communication via the second device, the first device is configured such that that further information characterizing a location of the first device obtained over the wide area network does not match the information obtained prior to initiating the communication via the second server.

Services are received from the second server according to the information characterizing the location of the first device.

The services from the second server include telecommunication services.

Obtaining the information characterizing the location of the first device includes obtaining the information from a reference server over the wide area network.

Obtaining the information from the reference server is performed prior to initiating the routing of communication via the second server.

obtaining information characterizing the location of the first device includes obtaining an address that is valid on the wide area network for directing communication to the first device.

The address that is valid on the wide area network comprises a routable network address.

Obtaining the address includes interacting with a reference server on the wide area network to obtain the address. The reference server can include a STUN server.

Communication from the first device that includes the information characterizing the location of the first device is received at the second server, and the second server provides services to the first device according to the received information characterizing the location.

The information characterizing the location includes a first network address on a wide area network associated with the first device. The first network address is different than a second network address on the wide area network to which communication associated with the provided services are directed.

In another aspect, in general, a method for providing services over a wide area network includes receiving from a first device communication including information characterizing a location of the first device, and providing services to the first device according to the received information characterizing the location. The information characterizing the location includes a first network address on a wide area network associated with the first device. The first network address is different than a second network address on the wide area network to which communication associated with the provided services are directed.

In another aspect, in general, software includes instructions stored on a machine-readable medium for causing a processing device to establish communication between a first device and a wide area data network, to obtain information characterizing a location of the first device over the wide area network, to route communication to a first server via a second server, the second server being at a location not characterized by the obtained information, and to pass the information characterizing the location of the first device from the first device via the first server to the second server.

Advantages can include one or more of the following.

Location-dependent services can be provided to a client computer via a communication tunnel in a way that depends on the location of the client endpoint of the tunnel.

Existing protocols and servers can be used to determine location-related information for the client, for example, using existing STUN servers. New capabilities are not necessarily required on the client's LAN to provide the location information.

Other features and advantages of the invention are apparent from the following description, and from the claims.

### DESCRIPTION OF DRAWINGS

FIG. 1 is a block diagram.

FIGS. 2A-B are timing diagrams.

### DESCRIPTION

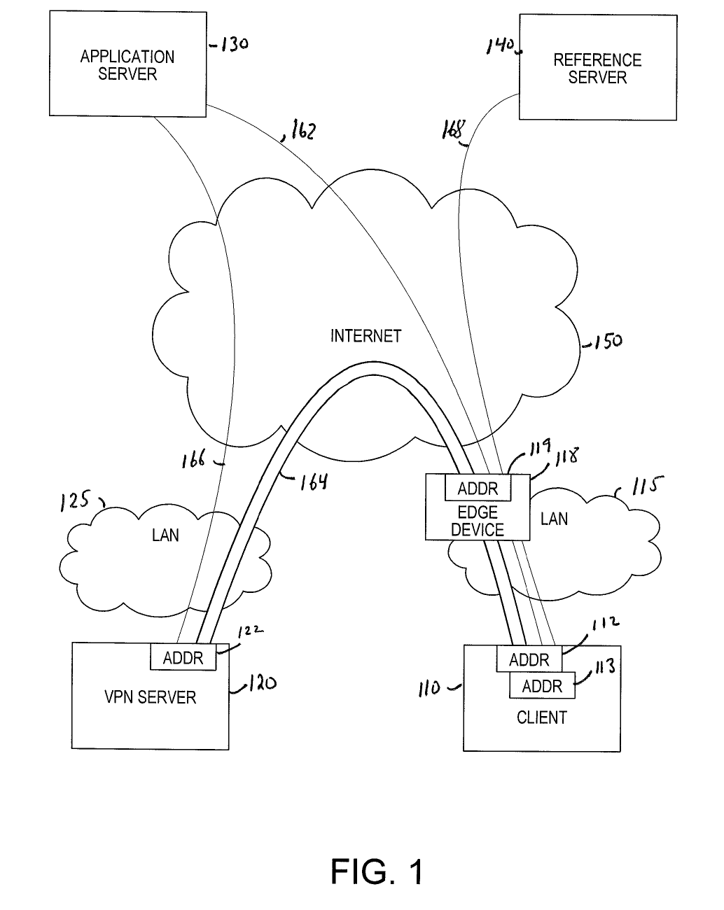

Referring to FIG. 1, a client computer 110 is on a Local Area Network (LAN) 115. For example, the client computer is being used by a mobile worker who has traveled to a remote location, e.g., a hotel room in Europe that has access to a hotel based LAN. The worker needs to access resources on a LAN 125 at another location. For example, the worker's employer may have a computer facility in the United States that includes services such as e-mail, file services, etc. In order to have access to the service on the LAN 125, the client computer establishes a communication tunnel 164 from the client computer to a Virtual Private Network (VPN) server 120 that is on the LAN 125 In some examples, the client computer 112 uses a Microsoft Windows operating system, and the tunnel is formed using native features of the operating system.

In some examples of the approaches described in this document, the client computer 110 is present on a LAN 115 on which private Internet Protocol (IP) addresses are used. An edge device 118 implements a Network Address Translation (NAT) approach that translates between a private address 112 for the client computer and a public routable address 119 that is assigned to the edge device 118. Use of such private addresses 112 is described in RFC 1918—Address Allocation for Private Internets, February 1996. The routable address 119 is typically statically assigned or dynamically provided by a network service provided that provides Internet communication services to the LAN 115. The private address 112 is typically dynamically provided when the client computer initializes its network services, for example, soon after it is initially powered up. In some examples, the edge device 118 implements a Dynamic Host Configuration Protocol (DHCP) that is used to provide the private network address 112 to the client computer 110. Note that the private address 112 does not typically provide information about the physical location of the client computer 110.

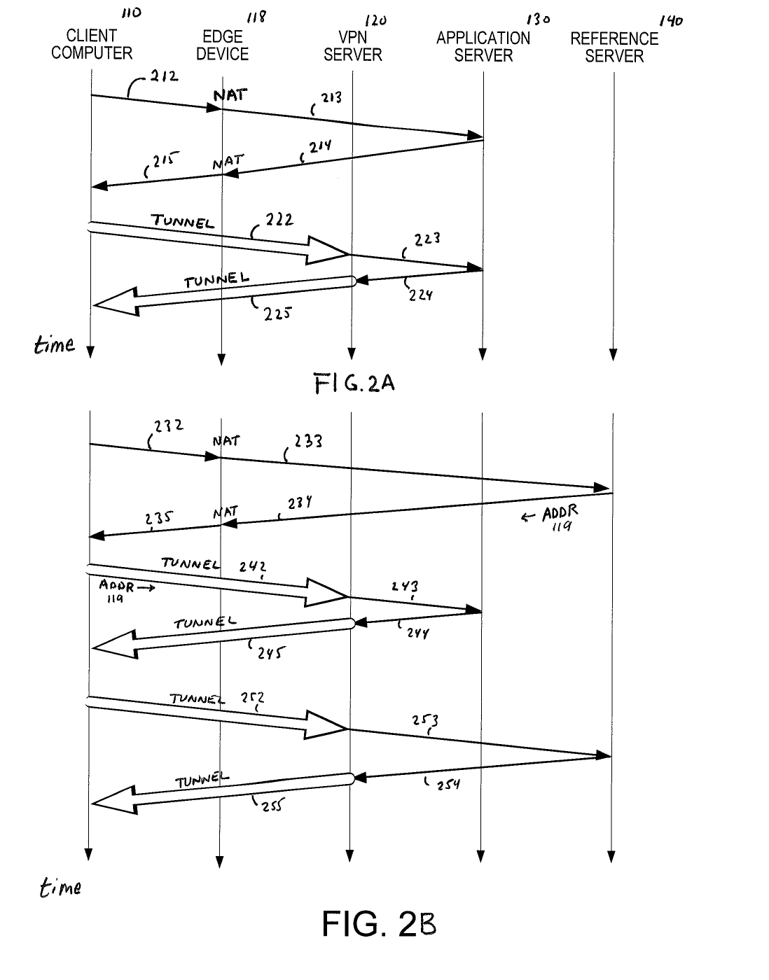

Referring also to FIG. 2A, prior to establishing any communication tunnels that may divert traffic from the client computer, the client computer 110 may access an application sever 130, with communication with the server passing over a path 162 illustrated in FIG. 1. The communication passes from the client computer to the edge device (FIG. 2, 212). The edge device translates to source address for the communication from the private address 112 of the client computer to its public routable address 119. The communication is forwarded to the application server (213). From the application server's point of view, the client computer 110 is accessible at the routable address 119 of the edge device. In some examples, the application server provides different services, or charges different fees for services based on the location of the client computer. One example of how the application server determines the location of the server is by mapping the routable address 119 to a geographic location. In some examples, such a mapping may be based on a table that maps particular ranges of addresses to general geographic locations, or based on centralized location registration possibly based on Domain Name Registration (DNS) approaches. The application server responds to the client computer by directing the communication to the edge device (214) which forwards the communication to the client computer.

As an example of an application server 130, the server provides communication services, which may depend on the location of the client. For example, a telephone number provided by the client may be interpreted according to the country in which the client is present, or toll charges may be applied based on the countries in which the client computer is physically located.

As introduced above, the client computer 110 may establish a communication tunnel 164 to a VPN server 120 on a remote LAN 125. In some examples of such an approach, the client computer 110 is provided with a local IP address 113 in the range of address for the remote LAN 125. The VPN server 120 then provides a routing function so that communication it receives over the tunnel 164 is passed to the appropriate location on the LAN 125, or passed to the Internet. In some examples, after then tunnel 164 is established between the client computer and the VPN server 120, an IP traffic originating from the client computer 110 passes first through the tunnel 164.

Once the tunnel 164 is established, if the client computer accesses the application server 130, its communication first passes over the tunnel 164 (222), and then from LAN 125 to the application server over path 166 (223). From the point of view of the application server, the communication is coming from LAN 125 rather than from LAN 115. For example, if LAN 125 is in the United States and LAN 115 is in Europe, the application server 130 thinks that the client is in the United States. The application server then responds to the client computer (224) as it if the client computer was on LAN 125, and the VPN server forwards the communication to the client computer (225).

Referring to FIG. 2B, in a mode of operation that provides the application server with more accurate location information, prior to establishing the communication tunnel 164 the client computer 110 obtains location-related information that is later passes to the application server via the tunnel. An example of such location-related information is the routable IP address 119 of the edge device 118 on the LAN 115.

In some examples, the client computer 110 obtains the location-related information by accessing a server, referred to herein as the reference server 140, over the Internet. In some examples, the reference server implements a STUN server, as described in RFC 3489—STUN—Simple Traversal of User Datagram Protocol (UDP) Through Network Address Translators (NATs), March 2003. In such examples, a STUN client hosted at the client computer interacts with the STUN server at the time the client computer 110 establishes communication with the Internet, for example, as part of the boot process for the computer. The communication for passes from the client computer to the edge device (232), the edge device translates the source address to its routable address 119, and passes the communication to the STUN server (233). The STUN server returns the address 119 back to the edge device (234), which forwards it to the client computer (235). Therefore, the STUN client at the client computer obtains the routable address 119, which it stores on the client computer.

Later, after the client computer establishes the tunnel 164, it provides the stored address 199 via the tunnel to the application server 130 (242, 243), for example, as part of an application layer protocol between an application executing on the client computer and a server application executing on the application server 130. The application server receives the client's routable address 119 and provides services based on the address (via 244, 245), rather than based on the routable source address of the communication it received via LAN 125. In this way, the application server can provide the same services to the client computer regardless of if it is communicating directly over path 162, or indirectly over tunnel 164 and path 166.

Note that if after establishing the tunnel 164 all IP communication from the client is passed first over the tunnel, then if the client computer were to access the reference server 140, that communication would first pass over the tunnel (252) and then to the reference server (253). A STUN server implemented at the reference server 140 would provide in response (254, 255) a routable address that is different than address 119, for example, the address of an edge device that links LAN 125 and the Internet.

Some examples do not necessarily involve use of communication tunnels. For example, other forms of re-routing of traffic in such a way that an application server may not be able determine the physical location of the client computer may make the approaches described above applicable.

In some examples, the function of determining and recording the routable address may be performed at a device separate from the client computer. For example, a router that functions as the edge device for a remote LAN may form the tunnel to the VPN server, and may introduce its routable address 119 into an application layer stream passing to the application server.

In some examples, the address 112 of the client computer itself provides sufficient location-related information, so the client computer does not have to interact with the reference server 140 in order to obtain location-related information that it will provide to the application server.

In some examples, the functions described for a client computer are performed in a device other than a client computer. For example, a router that functions as an edge device for the LAN 115 may also form a VPN endpoint, and the router itself may obtain and store the location-related information, which may consist of the routable address 119 of the router. In some examples, the edge device itself may perform a communication registration (e.g., registration with a SIP server) over the tunnel and provide the location-related information as part of the registration.

It should be understood that the client “computer” does not necessarily have to be a general purpose personal computer. For example, the client computer may be a voice-over-IP telephone that establishes a communication tunnel with a remote IP-based PBX.

In some examples, the tunnel 164 is not necessarily formed over the same data network as communication passing between the client computer and the application server (e.g., over the Internet 150). For example, the client computer may receive a routable IP address from a local server over a wireless LAN, but then direct its IP-based communication over a private IP-based network that uses separate communication links (e.g., a cellular telephone based IP network).

In some example, the tunnel 164 is formed between the edge device 118 and the VPN server 120, rather than between the client computer 110 and the VPN server, and the client computer obtains the location-related information prior to its traffic being routed over the tunnel (e.g., before the tunnel is formed or before its routing tables result in its traffic being routed over the tunnel).

In some examples, the client computer receives location information in the form of a civic address from a DHCP server, for example, at the same time that it receives its private address 112. In some such examples, after the tunnel 164 is formed, a further DHCP request from the client computer would be sent to a different DHCP server that is on the remote LAN 125, and therefore the client computer would receive a different civic address. However, the client computer can store the civic address it initially receives from its LAN 115, and then passes that civic address to the application server 130 via the tunnel 164.

In various examples, different mechanisms can be used to initiate the interaction with the reference server (or otherwise obtaining location related information) before establishing communication tunnel. For example, a boot script can include instructions for contacting the reference server. Similarly, a network startup script can include the needed instructions. In some example, the communication tunnel is established during execution of an application, and the application can include the instructions for obtaining the location information prior to establishing the tunnel.

Examples of the approach are implemented in software, in hardware, or in a combination of hardware and software. The software can include instructions embodied on a machine-readable medium (for example, an optical disk, solid state memory, or on a carrier propagating on a medium such as over a data link of a network). The instructions can be executed on a general purpose computer (for example, on the client computer), or can be executed on special purpose hardware (for example, on a communication device in the client computer, or in a network device such as a router). The instructions can be, without limitation, native instructions for a processor, instructions for a virtual machine, or interpreter instructions.

It is to be understood that the foregoing description is intended to illustrate and not to limit the scope of the invention, which is defined by the scope of the appended claims. Other embodiments are within the scope of the following claims.

What is claimed is:

1. A method for accessing a network based service comprising:
establishing communication between a first device and a wide area data network;
obtaining information characterizing a location of the first device over the wide area network;
routing communication to a first server via a second server, the second server being at a location not characterized by the obtained information; and
passing the information characterizing the location of the first device from the first device via the first server to the second server.

2. The method of claim 1 wherein routing communication to the first server via the second server includes forming a communication tunnel to the second server for communication from the first device.

3. The method of claim 1 wherein the routing of communication via the second server is initiated after obtaining the information characterizing the location of the first device.

4. The method of claim 3 wherein while routing communication via the second device, the first device is configured such that that further information characterizing a location of the first device obtained over the wide area network does not match the information obtained prior to initiating the communication via the second server.

5. The method of claim 1 further comprising:
receiving services from the second server according to the information characterizing the location of the first device.

6. The method of claim 5 wherein receiving the services from the second server includes receiving telecommunication services.

7. The method of claim 1 further wherein obtaining the information characterizing the location of the first device includes obtaining the information from a reference server over the wide area network.

8. The method of claim 7 wherein obtaining the information from the reference server is performed prior to initiating the routing communication via the second server.

9. The method of claim 1 wherein obtaining information characterizing the location of the first device includes obtaining an address that is valid on the wide area network for directing communication to the first device.

10. The method of claim 9 wherein the address that is valid on the wide area network comprises a routable network address.

11. The method of claim 9 wherein obtaining the address comprising interacting with a reference server on the wide area network to obtain the address.

12. The method of claim 11 wherein interacting with the reference server includes interacting with a STUN server.

13. The method of claim 1 further comprising:
receiving communication from the first device that includes the information characterizing the location of the first device; and
providing services to the first device according to the received information characterizing the location.

14. The method of claim 13 wherein the information characterizing the location comprises a first network address on a wide area network associated with the first device, the first network address being different than a second network address on the wide area network to which communication associated with the provided services are directed.

15. A method for providing services over a wide area network comprising:
receiving from a first device communication including information characterizing a location of the first device; and
providing services to the first device according to the received information characterizing the location;
wherein the information characterizing the location comprises a first network address on a wide area network associated with the first device, the first network address being different than a second network address on the wide area network to which communication associated with the provided services are directed.

16. Software comprising instructions stored on a machine-readable medium for causing a processing device to:
establish communication between a first device and a wide area data network;
obtain information characterizing a location of the first device over the wide area network;
route communication to a first server via a second server, the second server being at a location not characterized by the obtained information; and
pass the information characterizing the location of the first device from the first device via the first server to the second server.
